(19) United States
(12) Patent Application Publication
(10) Pub. No.: US 2014/0075754 A1
(43) Pub. Date: Mar. 20, 2014

(54) SYSTEM METHOD FOR MACHINING AIRCRAFT COMPONENTS

(71) Applicants: Alan C. Barron, Jupiter, FL (US); Mark F. Zelesky, Bolton, CT (US); Charles A. Blizzard, Royal Palm Beach, FL (US); Gregory A. Gilbert, Jupiter, FL (US); James Masloski, Lake Worth, FL (US); Allan J. Brockett, Vernon, CT (US); Jeffrey P. Smith, Glastonbury, CT (US); Bartolomeo Palmieri, Guilford, CT (US); Aleah J. Edwards, Kensington, CT (US)

(72) Inventors: Alan C. Barron, Jupiter, FL (US); Mark F. Zelesky, Bolton, CT (US); Charles A. Blizzard, Royal Palm Beach, FL (US); Gregory A. Gilbert, Jupiter, FL (US); James Masloski, Lake Worth, FL (US); Allan J. Brockett, Vernon, CT (US); Jeffrey P. Smith, Glastonbury, CT (US); Bartolomeo Palmieri, Guilford, CT (US); Aleah J. Edwards, Kensington, CT (US)

(73) Assignee: UNITED TECHNOLOGIES CORPORATION, Hartford, CT (US)

(21) Appl. No.: 13/692,525

(22) Filed: Dec. 3, 2012

Related U.S. Application Data
(60) Provisional application No. 61/702,282, filed on Sep. 18, 2012.

(51) Int. Cl. B23Q 15/007; B23P 15/02; B25J 9/00; B23P 13/00

(52) U.S. Cl. CPC B23Q 15/007; B23P 13/00; B23P 15/02; B25J 9/00; Y10S 901/41; Y10S 901/02; Y10S 901/47
USPC 29/888.012; 29/407.01; 29/407.04; 700/159; 700/195; 901/41; 901/2; 901/47

(57) ABSTRACT

A method for manufacturing an aircraft component according to one embodiment of this disclosure includes providing a machining system including a controller, at least one sensor, and a tool for machining. The method further includes providing an aircraft component, and machining the aircraft component with the tool based on feedback from the at least one sensor.

### RELATED APPLICATIONS

This disclosure claims the benefit of U.S. Provisional Application No. 61/702,282 filed 18 Sep. 2012, the entirety of which is herein incorporated by reference.

### BACKGROUND

Known machining systems are programmed such that a tool follows a particular path. The path is selected to correspond to a workpiece of known dimensions. When machining multiple workpieces in sequence, these known systems need to be reprogrammed, for each workpiece, such that the path of the tool corresponds to the specific dimensions of the particular workpiece.

Further, in the automotive industry, as an example, robotic assembly systems use sensory feedback when assembling complex components, such as automotive transmissions, to account for any inconsistencies, or misalignments, between individual components.

### SUMMARY

A method for manufacturing an aircraft component according to one embodiment of this disclosure includes providing a machining system including a controller, at least one sensor, and a tool for machining. The method further includes providing an aircraft component, and machining the aircraft component with the tool based on feedback from the at least one sensor.

In a further non-limiting embodiment of the present disclosure, the at least one sensor includes an optical sensor.

In a further non-limiting embodiment of the present disclosure, the at least one sensor includes a force sensor.

In a further non-limiting embodiment of the present disclosure, the controller is provided with a general instruction for machining the aircraft component.

In a further non-limiting embodiment of the present disclosure, the general instruction is adjusted based on feedback from the at least one sensor.

In a further non-limiting embodiment of the present disclosure, the aircraft component is an airfoil for a gas turbine engine.

In a further non-limiting embodiment of the present disclosure, the machining includes shaping a trailing edge of the airfoil.

In a further non-limiting embodiment of the present disclosure, the machining includes machining the trailing edge of the airfoil substantially to a point.

In a further non-limiting embodiment of the present disclosure, the machining includes shaping a leading edge of the airfoil.

In a further non-limiting embodiment of the present disclosure, the airfoil is cast before the machining step.

In a further non-limiting embodiment of the present disclosure, the airfoil is provided by an additive manufacturing process before the machining step.

In a further non-limiting embodiment of the present disclosure, the aircraft component is coated with a coating.

In a further non-limiting embodiment of the present disclosure, the machining includes removing excess coating from the aircraft component.

In a further non-limiting embodiment of the present disclosure, the aircraft component was originally formed using an additive manufacturing process.

In a further non-limiting embodiment of the present disclosure, the machining step includes removing imperfections due to incomplete fusing of powder particles during the additive manufacturing process.

A system for machining an aircraft component according to one embodiment of this disclosure includes an aircraft component, and a robot including a controller, at least one sensor, and a tool. The tool is configured to machine the aircraft component in response to instructions from the controller, the controller configured to provide instructions to the tool based on feedback from the at least one sensor.

In a further non-limiting embodiment of the present disclosure, the at least one sensor includes an optical sensor.

In a further non-limiting embodiment of the present disclosure, the at least one sensor includes a force sensor.

In a further non-limiting embodiment of the present disclosure, the controller is provided with a general instruction for machining the aircraft component.

In a further non-limiting embodiment of the present disclosure, the controller is configured to adjust the general instruction in response to feedback from the at least one sensor.

These and other features of the present disclosure can be best understood from the following drawings and detailed description.

### BRIEF DESCRIPTION OF THE DRAWINGS

The drawings can be briefly described as follows:

FIG. 1 schematically illustrates an example machining system.

FIG. 2 schematically illustrates an example wherein the machining system is used to machine a trailing edge of an airfoil.

FIG. 3 schematically illustrates an example wherein the machining system is used to machine a leading edge of an airfoil.

### DETAILED DESCRIPTION

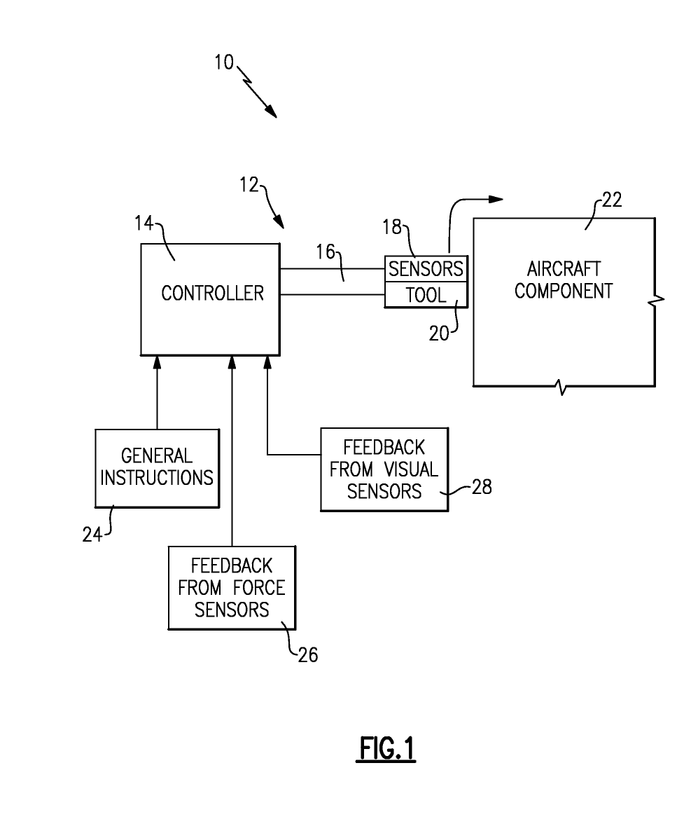

FIG. 1 illustrates an example robotic machining system 10 (“system 10”). The system 10 includes a robot 12 having a controller 14 and an arm 16. The system 10 further includes at least one sensor 18 and a tool 20 at a free end of the arm 16.

In one example, the at least one sensor 18 includes a force sensor and a visual sensor. Other sensors can be included, as desired, and this disclosure is not limited to any particular number of sensors. Regarding the force sensor, this disclosure extends to all types of force sensors (or “touch” sensors), including capacitive sensors, electromagnetic sensors, and piezoelectric sensors, as examples. Regarding the visual sensors, this disclosure extends to all types of visual sensors including optical sensors that include cameras and/or fiber optics. Further, the visual sensors do not need to be attached to the free end of the arm 16, and can instead be positioned in some other manner relative to the tool 20.

In an example method, an aircraft component 22 that is to be machined, is provided. In this example, the aircraft component 22 has been formed using a known process, such as casting, and is undergoing further machining or finishing. In this disclosure, the terms “machine” and “machining” are used to refer to both the original formation of a component and the subsequent finishing of a component.

Based on an expected geometry of the aircraft component 22, the controller 14 is provided with general instructions 24 for machining the aircraft component 22. During machining, feedback from the sensors 18, illustrated at 26 and 28, is provided to the controller 14. This feedback may indicate that the actual geometry of the aircraft component 22 is different than originally expected. For example, when a workpiece is smaller than expected, the force sensor would provide a lower reading than expected, or indicate that there has been no contact with the workpiece at all. When such a difference is detected, the controller 14 can adjust the path of the tool 20, and can continue to machine the aircraft component 22 such that it is provided with a desired finish.

As one example illustrating the above method, an aircraft component formed using an additive manufacturing process may exhibit an exterior surface with imperfections due to incomplete fusing of powder particles. In this case, the sensors 18 would detect these imperfections (if present), and the controller 14 would provide an updated path for the tool 20, in real time, to provide the desired finish to the aircraft component 22.

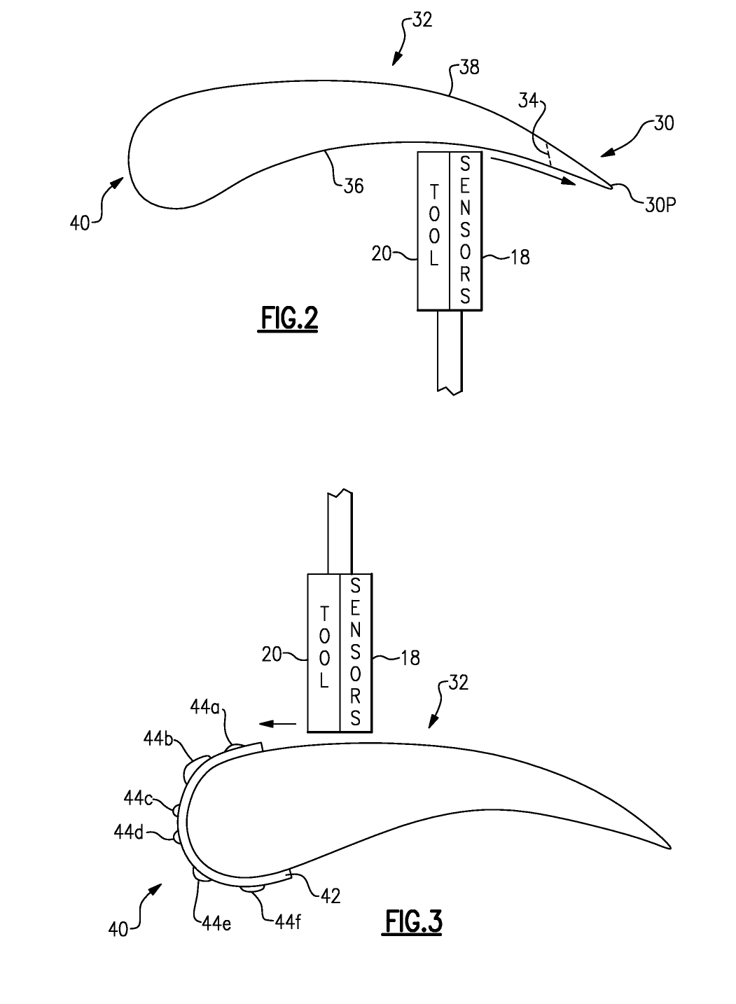

In a further example, the above method can be used to finish a trailing edge 30 of an airfoil 32. FIG. 2 schematically illustrates an airfoil 32 that has been formed by way of casting. Due to the nature of the casting process, the trailing edge 30 of the airfoil 32 must be further machined, or finished, in order to provide the airfoil with desired aerodynamic properties. In one known method, workers physically file the trailing edge 30 such that the airfoil 32 is provided with a squared-off edge, represented at 34.

Using the method of this disclosure, the feedback from the sensors 18 allows the tool 20 to be tracked along the inner and outer contours 36, 38 of the airfoil 32 such that the trailing edge 30 can be finished substantially down to a point, as represented at 30P. As used herein, “substantially” means within a range accepted by those in this art. By machining the trailing edge 30 down to the point 30P, the airfoil 32 is provided with enhanced aerodynamic properties relative to the squared-off edge 34. Further, by employing this method, the inaccuracies, time and costs associated with human labor are reduced.

With continued reference to FIG. 2, the disclosed method can further be used to finish the leading edge 40 of the airfoil 32 such that the leading edge 40 is provided with a desired shape. In this example, the controller 14 would be provided with a general instruction 26 for providing the leading edge 40 with a desired shape. The tool 20 would then be guided to machine the leading edge 40 accordingly, with adjustments based on feedback from the sensors 18. The improved machining accuracy provided by this disclosure further leads to enhanced aerodynamic properties for the airfoil 32.

In another example, the above method can be used to remove excess coating, such as a coating applied to the leading edge 40 of the airfoil 32. As illustrated in FIG. 3, an airfoil 32 is provided with a coating 42, by way of any number of known techniques (such as vapor deposition). The coating 42 in this example has been applied such that there is excess material at several points, indicated by reference numerals 44a-44f. Typically, such excess material would have to be removed manually.

With this disclosure, the excess material 44a-44f can be removed by providing the controller 14 with general instructions 24 indicating a desired coating thickness, and allowing the tool 20 to follow the general instructions 24 along the contour of the leading edge 40, as adjusted by the feedback from the sensors 18. As mentioned above, this method provides improved accuracy and efficiency relative to manual labor.

Accordingly, this disclosure can be used to provide consistency between machined components even though there may have been differences in dimensions between workpieces. Further, while the above example illustrates an airfoil 32, it should be understood that this disclosure extends to all types of aircraft components, and is not limited to airfoils.

The example herein can be applied relative to originally machined workpieces and to components that have already undergone prior machining. While several examples are listed above, the following is a list of non-limiting example processes in which the above discussed system and method can be used:
Machining of turbine airfoils (both blades and vanes)
Machining of turbine mid-frames and exit cases
Trailing edge shaping
Thermal barrier coating (TBC) finishing and tapering
Trailing edge and super vane core sky jump removal
Ceramic matrix composite (CMC) and monolithic ceramic air flow finishing
Machining of compressor airfoils, blades, integrally bladed rotors (IBRs), vanes, variable vanes
Machining of fan blades
Leading edge shaping
Tip and trailing edge shaping
Fan blade leading edge shaping replacing scraping
Airfoil side face coating removal
Airfoil cavity print out cleanup
Refractory metal core (RMC) cores tip hole TBC removal
Machining RMC root inlets
Trailing edge slot coating and flash removal
Film hole coating cleanup
RMC core finishing to add fillets
Ceramic core finishing
Cast clean up
Machining of combustor panel, blade outer air seals, and other flow path parts
Coating edge cleanup
Film hole cleanup
Adding fillets
Cleaning excess casting
Machining exhaust system components
TBC finishing, dressing and tapering
Laser hole re-drilling

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A method for manufacturing a component, comprising:
providing a machining system including a controller, at least one sensor, and a tool for machining;
providing a component; and
machining the component with the tool in response to feedback from the at least one sensor.

2. The method as recited in claim 1, wherein the at least one sensor includes an optical sensor.

3. The method as recited in claim 1, wherein the at least one sensor includes a force sensor.

4. The method as recited in claim 1, including providing the controller with a general instruction for machining the component.

5. The method as recited in claim 4, including adjusting the general instruction based on feedback from the at least one sensor.

6. The method as recited in claim 1, wherein the component is an airfoil for a gas turbine engine.

7. The method as recited in claim 6, wherein the machining includes shaping a trailing edge of the airfoil.

8. The method as recited in claim 7, wherein the machining includes machining the trailing edge of the airfoil substantially to a point.

9. The method as recited in claim 6, wherein the machining includes shaping a leading edge of the airfoil.

10. The method as recited in claim 6, wherein the airfoil is cast before the machining step.

11. The method as recited in claim 6, wherein the airfoil is provided by an additive manufacturing process before the machining step.

12. The method as recited in claim 1, wherein the component is coated with a coating.

13. The method as recited in claim 12, wherein the machining includes removing excess coating from the component.

14. The method as recited in claim 1, wherein the component was originally formed using an additive manufacturing process.

15. The method as recited in claim 14, wherein the machining step includes removing imperfections due to incomplete fusing of powder particles during the additive manufacturing process.

16. A system for machining an aircraft component, comprising:
an aircraft component; and
a robot including a controller, at least one sensor, and a tool, the tool configured to machine the aircraft component in response to instructions from the controller, the controller configured to provide instructions to the tool based on feedback from the at least one sensor.

17. The system as recited in claim 16, wherein the at least one sensor includes an optical sensor.

18. The system as recited in claim 17, wherein the at least one sensor includes a force sensor.

19. The system as recited in claim 16, wherein the controller is provided with a general instruction for machining the aircraft component.

20. The system as recited in claim 19, wherein the controller is configured to adjust the general instruction in response to feedback from the at least one sensor.
